(19) United States
(12) Patent Application Publication
(10) Pub. No.: US 2007/0041155 A1
(43) Pub. Date: Feb. 22, 2007

(54) Fixing frame for hard disk

(75) Inventor: Jui-Lin Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/393,447

(22) Filed: Mar. 29, 2006

(30) Foreign Application Priority Data
Aug. 17, 2005 (TW) 094214055

(51) Int. Cl. G06F 1/16

(52) U.S. Cl. 361/685

(57) ABSTRACT

A fixing frame for a hard disk, applied to a mother board having at least one supporting member with a first fastening portion and having at least one second fastening portion to fix the hard disk, includes at least one third fastening portion and at least one fourth fastening, wherein the third fastening portion is coupled to the first fastening portion and the fourth fastening portion is clamped to the second fastening portion.

### FIELD OF THE INVENTION

The present invention relates to assembly technique for electronic devices. More particularly, the invention relates to a fixing frame for a hard disk.

### BACKGROUND OF THE INVENTION

Electronic devices, such as hard disks, have become standard accessories of electronic products, for example, such as notebook computers, liquid crystal display computers, tablet computers and servers. Therefore, it is common that the aforementioned electronic devices are equipped with hard disks.

Generally, if it is needed to be equipped with hard disks, the hard disks will be installed to adapters for hard disks on the mother board and frames are used meanwhile in order to receive the hard disks. When frames are used to receive the hard disks, the hard disks are usually placed onto the frames, then connectors of the hard disks are connected with connectors of the adapters on the mother board each other. In this case, what would be considered is merely how to fasten the frames of the hard disks.

Now, there is a kind of new adapter which is detachable, that is, such an adapter is not locked to the mother board until the hard disk is needed to be disposed. As a result, inconvenient assembling and disassembling problems occur, because such an adapter also must be fastened. In addition, since such an adapter is locked to the mother board, it is necessary to use some particular tools for assembly/disassembly, thereby inconvenient for performance.

Furthermore, because the aforementioned frame is disposed on the surface of the mother board, the weight of the frame and the hard disk is supported by the mother board, such that the burden of the mother board with numerous electronic components and devices thereon will be increase. Consequently, not only the hard disk is difficult to be fixed firmly but also the connector of the hard disk and/or adapter is inclined to be damaged or have worse electrical connection due to lacking satisfactory structural strength of the mother board. Thereby, applications are adversely affected. Moreover, if components applied to the mother board can not be exactly arranged, positioned and fastened even damage or worse electrical connection occurs, it will lead to useless inferior products and higher defective percentage of products.

Additionally, regarding types of conventional connectors of hard disks, there are, for example, downward or backward electrically connected connectors. Only the hard disks with connectors downward electrically connected are applied to the mother board. It is available that one side of the aforementioned conventional frame is used to fix the mother board and the other side of the frame is used to stack the hard disk. However, this assembly technique apparently limits applications of the hard disks with connectors backward electrically connected, thus consumers and manufactures have less choices for hard disks. If this conventional assembly technique is utilized in the industry, it will reduce the utilities of hard disks.

Accordingly, there is an eager demand for developing a fixing frame for a hard disk, which overcome the above-mentioned shortcomings of the prior art and provides assembly technique for firmly fastening, easily and quickly assembling/ disassembling and performing without the need of any tools, and further reduces defective percentage of products and promotes the utilities of hard disks in the industry.

### SUMMARY OF THE INVENTION

To overcome the above-mentioned problems, it is a primary objective of the present invention to provide a fixing frame for a hard disk that can be firmly fixed.

It is another objective of the present invention to provide a fixing frame for a hard disk that make assembly/disassembly simple and quick.

It is a further objective of the present invention to provide a fixing frame for a hard disk that is detachable without the needs of any tools.

It is still another objective of the present invention to provide a fixing frame for a hard disk with less defective percentage of products.

It is still a further objective of the present invention to provide a fixing frame for a hard disk that can promote the utilities of hard disks in the industry.

To achieve the above-mentioned and other objectives, a fixing frame for a hard disk is provided according to a preferred embodiment of the present invention, which is applied to a mother board having at least one supporting member with a first fastening portion and having at least one second fastening portion to fix the hard disk, wherein the fixing frame for a hard disk comprises at least one third fastening portion, coupled to the first fastening portion; and one fourth fastening portion, clamped to the second fastening portion.

Preferably, two third fastening portions and two fourth fastening portions are provided. The third fastening portion may be an opening or the like. The fourth fastening portion is optionally a hooking member or the like. The fixing frame for a hard disk further comprises an accommodating space, a plurality of locking portions and two holding portions. Alternatively, the accommodating space is rectangular. These locking portions are distributed, for example, to the corners of the accommodating space. The holding portions are extended upward from two lateral sides of the accommodating space respectively.

The conventional frames are disposed on the surface of the mother board and the weight of the frame and the hard disk is supported by the mother board, thus the burden of the mother board is increased. As a result, the hard disk is difficult to be fixed firmly and the connector of the hard disk and/or the connector of the adapter are inclined to be damaged or have worse electrical connection due to lacking satisfactory structural strength of the mother board. Comparing with the disadvantages of the prior art, the present invention allows the fourth fastening portion of the fixing frame for a hard disk to be fastened at the second fastening portion on the mother board, and the third fastening portion of the fixing frame for a hard disk to be coupled to the first fastening portion of the supporting member on the mother board in order to elevate the fixing frame in which the hard disk is stacked.

Accordingly, it is not only to provide a fixing frame for a hard disk, which can fix hard disks firmly on the mother board, but also to make assembling/disassembling processes more convenient because of needing no tools to assemble the hard disks to the mother boards and disassemble the hard disks from the mother board.

Moreover, the fixing frame for a hard disk of the present invention is designed that one end of the fixing frame through the third fastening portion of the fixing frame is coupled to the first fastening portion of the supporting member on the mother board in order to position in the up, down, front, rear, left and right directions and the other end has the fourth fastening portion with a clamping member, clamped to the mother board, in order to position in the up and down directions and then couple detachable adapters to fasten adapters which was not steadily disposed. Therefore, the present invention can solve the problems of the prior art that components can not be firmly arranged, positioned and fastened, even damage or worse electrically connection occurs, leading to useless inferior products and higher defective percentage of products.

In addition, the fixing frame of the present invention can be applied to assemble the hard disks with adapters downward electrically connected to the mother board. This overcomes the limits for specifications of hard disks utilizing conventional assembling technique and provides choices of hard disks for consumers and manufacturers. Therefore, the present invention can promote the utilities of hard disks in the industry.

Accordingly, the fixing frame of the present invention can overcome the above-mentioned problems of the prior art and provides assembly technique for firmly fastening, easily and quickly assembling/disassembling and performing without the need of any tools, and further reduces defective percentage of products and promotes the utilities of hard disks in the industry.

The following illustrative embodiments are provided to exemplify the present invention, these and other advantages and effects can be apparently understood by those in the art according to the disclosure of this specification. The present invention can also be performed or applied by other different embodiments. The details of the specification may be variously modified and changed based on different points and application without departing from the spirit of the present invention.

### BRIEF DESCRIPTION OF THE DRAWINGS

FIGS. 1A to 1B are schematic views showing a preferred embodiment of the present invention in performance.

FIG. 2 is a perspective view showing a supporting member in a preferred embodiment of the present invention.

FIGS. 3A to 3E are a schematic view of a preferred embodiment of the fixing frame for a hard disk of the present invention, wherein FIG. 3B is a rear side view of FIG. 3A; FIG. 3C is a left side view of FIG. 3A; FIG. 3D is a right side view of FIG. 3A; and FIG. 3E is a perspective view of FIG. 3A.

FIG. 4 is a perspective view showing an adapter in a preferred embodiment of the present invention.

### DETAILED DESCRIPTION OF THE PREFERD EMBODIMENT

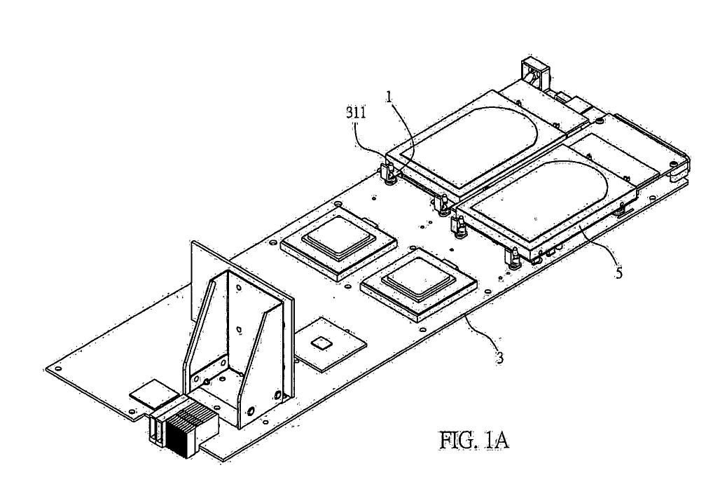

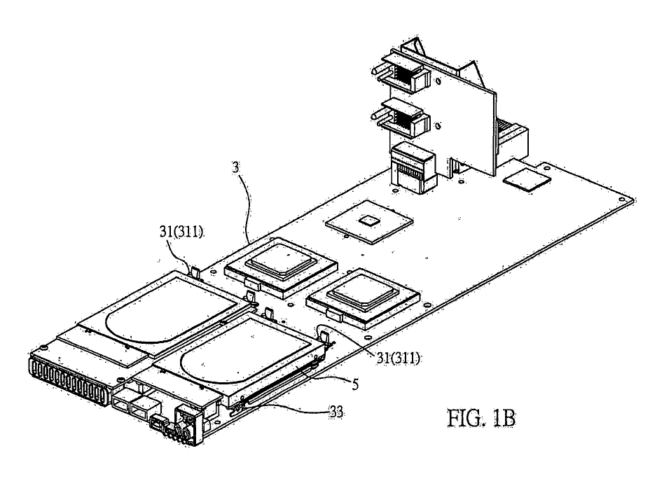

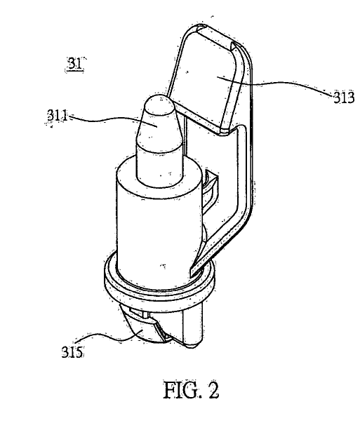

FIG. 1A to 4 are schematic views of preferred embodiments of the present invention. Referring to FIGS. 1A and 1B, a fixing frame 1 for a hard disk of the present invention is applied to a mother board 3 so as to fix a hard disk 5, wherein the mother board 3 has at least one supporting member 31 with a first fastening portion 311 and has at least one second fastening portion 33. As shown in FIG. 1A in view of FIG. 2, the supporting member 31 has a column-like first fastening portion 311 and the supporting member 31 further has a resilient hooking member 313 and a clamping member 315, wherein the clamping member 315 is apart from the first fastening portion 311 and can be clamped to the mother board 3. As shown in FIG. 1B, the second fastening portion may be a slot for positioning.

It is noted that the mother board 3 and the hard disk 5 in the embodiment are exemplified but not restricted. The configuration of the mother board 3 is not limited to the configuration as shown in drawings, which may vary according to the actual need. These drawings all are simple schematic views for purposes of illustrating the configurations of the present invention and merely show related components of the invention, wherein the numbers, shapes and dimensions of the components are draw regardless of the actual performance and they may be varied in the actual performance and the configuration may be more complicated.

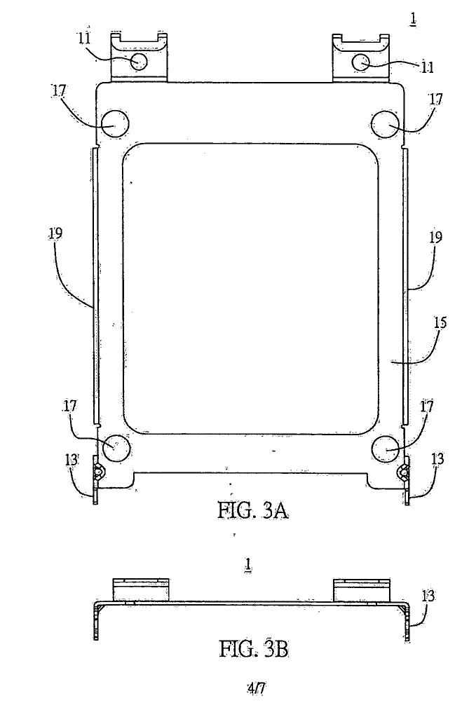

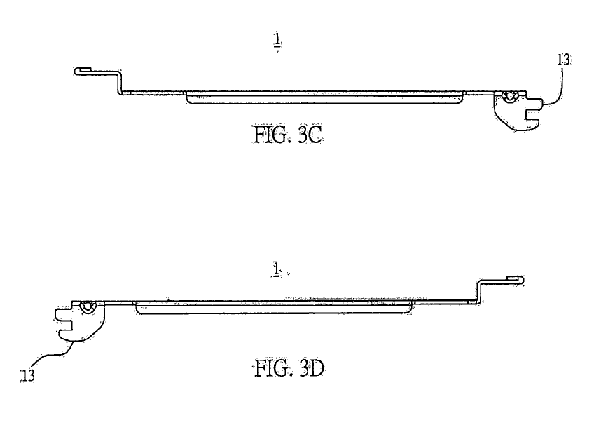

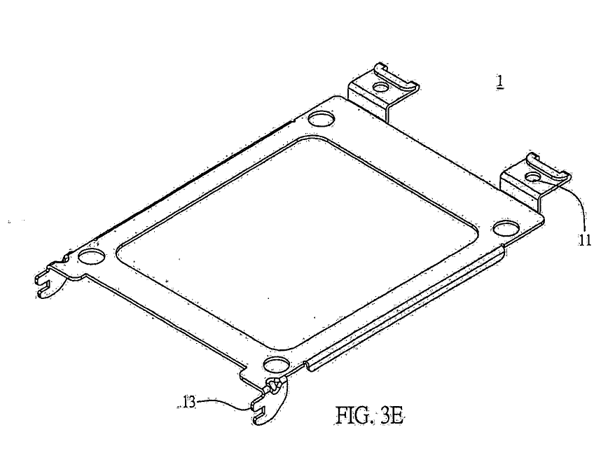

Referring to FIG. 3A to 3E, the fixing frame for a hard disk comprises at least one third fastening portion 11 and at least one fourth fastening portion 13. As shown in FIG. 3A in view of FIG. 1A, the third fastening portion 11 is copuled to the first fastening portion 311, wherein the third fastening portion 11 is a opening or the like. As shown in FIG. 3E in view of FIG. 1B, the fourth fastening portion 13 is clamped to the second fastening portion 33, wherein the fourth fastening portion 13 may be a hooking member or the like.

Moreover, as shown in FIG. 3A in view of FIG. 1B, the fixing frame 1 for a hard disk further comprises an accommodating space 15, four locking portions 17 and two holding portions 19. In the present invention, the accommodating space 15 is basically rectangular. The holding members 19 are extend upward from two lateral sides of the accommodating space 15, wherein the hard disk 5 is received by the accommodating space 15. The hard disk 5 is locked by the locking portions 17 and held on the fixing frame 1 by the holding portions 19.

It is understood that although two third fastening portions 11 and two fourth fastening portions are presented in the invention, it is not limited and other numbers of and positions for the third fastening portion 11 and the fourth fastening portion 13 may be disposed. Further, the shapes, sizes, numbers and positions of the accommodating space 15, the locking portions 17 and two holding portions 19 may be varied according to the hard disk 5 received. Such variations should be readily thought and achieved by those skilled in the art, therefore its detailed description is omitted herein.

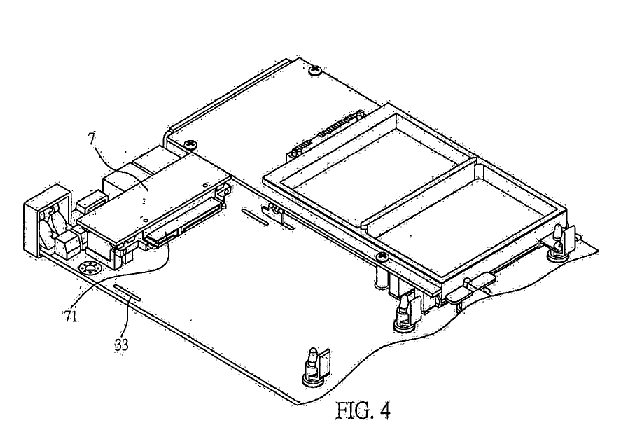

When the hard disk 5 is needed to be fixed on the mother board 3 by the fixing frame 1, the hard disk 5 is firstly locked to the fixing frame 1 through the locking portion 17 of the fixing frame 1. Secondly, the third portion 11 of the fixing frame 1 is coupled to the first fastening portions 311 of the supporting member 31 on the mother board 3, and the fourth portion 13 of the fixing frame 1 is clamped to the second fastening portion 33 of the mother board, while the hooking member 313 of the supporting member 31 is hooked to the third fastening portion 11 of the fixing frame 1, keeping the third fastening portion 11 between the first fastening portion 311 and the hooking member 313 and allowing the clamping member 315 of the supporting member 31 to be clamped to the mother board 3. Finally, the connector (not shown) of the hard disk 5 is combined to the connector 71 of the adaptor 7 as shown in FIG. 4, thus the hard disk 5 is steadily fixed on the mother board 3. The assembly completed is shown in FIGS. 1A and 1B.

As shown in FIGS. 1A and 1B, the weight of fixing frames using conventional technique, which is exerted to the mother board, can be shared by the third fastening portion 11 of the fixing frame 1 because the third fastening portion 11 is coupled to the first fastening portion 311 on the mother board 3. Thus, this assembly has superior structural strength than before and facilitates to fix a hard disk steadily. Therefore, the fixing frame for a hard disk, the hard disk firmly fixed thereby, is provided in the present invention.

Furthermore, the fixing frame 1 can be held on the mother board 3 by the supporting member 31, thus the hard disk 5 on the fixing frame 1 is electrically connected with the adapter 7 exactly. Compared with conventional technique using special tools for locking a adapter to a mother board, the assembling and disassembling processes in the present invention are relatively simple and quick, in which it does not need any tools to equip the mother board 3 with the fixing frame 1 or detach the fixing frame 1 from the mother board 3. Accordingly, the present invention is convenient to assemble and disassemble.

Additionally, the third fastening portion 11 of the fixing frame 1 is, for example, an opening, and is coupled correspondently to the first fastening portion 311, for example a column, thus a flexible distance (as shown in FIG. 1B) between the third fastening portion 11 and the mother board 3 for coupling can be provided by the first fastening portion 311. Because the fourth fastening portion 13 of the fixing frame 1 is combined to the second fastening portion 33 by clamping members, it keep the hook-like part of the fourth fastening portion 13 flexible, thus the fourth fastening portion 13 can be assembled or disassembled by hand. Therefore, the assembling or disassembling processes are carried out in the present invention without the need of any tools.

Moreover, the components of the present invention can be exactly arranged, positioned, fastened, and good electrically connected, so it can solve the problems of defective products caused by the prior art and reduce the percentage of defective products. In addition, the present invention can be applied to hard disks with adapters downward electrically connected, thus the present invention overcomes restrictions of hard disks utilizing conventional assembling technique and provides flexibilities of hard disks for consumers and manufacturers. Accordingly, the present invention can promote the utilities of hard disks in the industry.

The fixing frame of the present invention not only can firmly fix hard disks to mother boards, allowing assembling and disassembling processes simple, quick and without the need of any tools, but also can reduce the defective percentage of products, even promote effects of hard disks. Accordingly, the present invention overcomes the above-mentioned problems of the prior art and provides the above-mentioned functions, thus the present invention is very valuable in the industry.

The foregoing detailed descriptions of the embodiments have been presented for illustrating the features and functions of the present invention and not for limiting the scope of the present invention. Those skilled in the art will appreciate that modifications and variations according to the spirit and principle of the present invention may be made. All such modifications and variations are considered to fall within the spirit and scope of the present invention as defined by the appended claims.

What is claimed is:

1. A fixing frame for a hard disk, applied to a mother board having at least one supporting member with a first fastening portion and having at least one second fastening portion to fix the hard disk, the fixing frame comprising:
at least one third fastening portion coupled to the first fastening portion; and
at least one fourth fastening portion clamped to the second fastening portion.

2. The fixing frame of claim 1, wherein the at least one third fastening portion comprises two third fastening portions.

3. The fixing frame of claim 1, wherein the third fastening portion is an opening.

4. The fixing frame of claim 1, wherein the at least one fourth fastening portion comprises two fourth fastening portions.

5. The fixing frame of claim 1, wherein the fourth fastening portion is a hooking member.

6. The fixing frame of claim 1, further comprising an accommodating space, a plurality of locking portions and two holding portions.

7. The fixing frame of claim 6, wherein the accommodating space is rectangular.

8. The fixing frame of claim 6, wherein the locking portions are disposed at corners of the accommodating space.

9. The fixing frame of claim 6, wherein the holding portions are extended upward from two lateral sides of the accommodating space.
